(19) United States
(12) Patent Application Publication
(10) Pub. No.: US 2021/0229885 A1
(43) Pub. Date: Jul. 29, 2021

(54) Carrier For Containers

(71) Applicant: Graphic Packaging International, LLC, Atlanta, GA (US)

(72) Inventors: Justin McCree, Bristol (GB); Brian Smalley, Bristol (GB); Steve M. Gould, Bristol (GB)

(21) Appl. No.: 17/231,368

(22) Filed: Apr. 15, 2021

Related U.S. Application Data
(62) Division of application No. 16/426,050, filed on May 30, 2019, now Pat. No. 11,014,727.
(60) Provisional application No. 62/779,689, filed on Dec. 14, 2018.
(60) Provisional application No. 62/783,752, filed on Dec. 21, 2018.
(60) Provisional application No. 62/796,830, filed on Jan. 25, 2019.
(60) Provisional application No. 62/797,585, filed on Jan. 28, 2019.
(60) Provisional application No. 62/810,015, filed on Feb. 25, 2019.
(60) Provisional application No. 62/814,412, filed on Mar. 6, 2019.
(60) Provisional application No. 62/817,120, filed on Mar. 12, 2019.
(60) Provisional application No. 62/841,449, filed on May 1, 2019.

(51) Int. Cl. B65D 71/44; B31B 50/86; B31B 50/20; B31B 50/62; B31B 50/73; B31B 50/00; B31B 50/04; B31B 50/52

(52) U.S. Cl. CPC B65D 71/44; B31B 50/86; B31B 50/20; B31B 50/52; B31B 50/734; B31B 50/006; B31B 50/04; B31B 50/624

(57) ABSTRACT

A carrier for holding a plurality of containers includes a plurality of panels, the plurality of panels includes at least one central panel and at least one attachment panel for receiving a portion of one or more containers of the plurality of containers. The at least one central panel is for being positioned between adjacent containers of the plurality of containers, and the at least one attachment panel is foldably connected to the at least one central panel. At least one divider flap is foldably connected to the at least one central panel. The at least one attachment panel is positionable between a first position and a second position. In the first position the at least one attachment panel overlies and receives a portion of one or more of the containers. In the second position the at least one attachment panel is folded relative to the at least one central panel and in an upright position to form a handle for carrying the carrier.

### CROSS-REFERENCE TO RELATED APPLICATIONS

This application is a divisional application of U.S. patent application Ser. No. 16/426,050, filed on May 30, 2019, which claims the benefit of each of U.S. Provisional Patent Application No. 62/779,689, filed on Dec. 14, 2018, U.S. Provisional Patent Application No. 62/783,752, filed on Dec. 21, 2018, U.S. Provisional Patent Application No. 62/796,830, filed on Jan. 25, 2019, U.S. Provisional Patent Application No. 62/797,585, filed on Jan. 28, 2019, and U.S. Provisional Patent Application No. 62/810,015, filed on Feb. 25, 2019, U.S. Provisional Patent Application No. 62/814,412, filed on Mar. 6, 2019, U.S. Provisional Patent Application No. 62/817,120, filed on Mar. 12, 2019, and U.S. Provisional Patent Application No. 62/841,449, filed on May 1, 2019.

### INCORPORATION BY REFERENCE

The disclosures of each of U.S. patent application Ser. No. 16/426,050, filed on May 30, 2019, U.S. Provisional Patent Application No. 62/779,689, filed on Dec. 14, 2018, U.S. Provisional Patent Application No. 62/783,752, filed on Dec. 21, 2018, U.S. Provisional Patent Application No. 62/796,830, filed on Jan. 25, 2019, U.S. Provisional Patent Application No. 62/797,585, filed on Jan. 28, 2019, and U.S. Provisional Patent Application No. 62/810,015, filed on Feb. 25, 2019, U.S. Provisional Patent Application No. 62/814,412, filed on Mar. 6, 2019, U.S. Provisional Patent Application No. 62/817,120, filed on Mar. 12, 2019, and U.S. Provisional Patent Application No. 62/841,449, filed on May 1, 2019, are hereby incorporated by reference for all purposes as if presented herein in their entirety.

### BACKGROUND OF THE DISCLOSURE

The present disclosure generally relates to carriers or cartons for holding, displaying, and/or transporting containers.

### SUMMARY OF THE DISCLOSURE

According to one aspect of the disclosure, a carrier for holding a plurality of containers comprises a plurality of panels, the plurality of panels comprising at least one central panel and at least one attachment panel for receiving a portion of one or more containers of the plurality of containers. The at least one central panel is for being positioned between adjacent containers of the plurality of containers, and the at least one attachment panel is foldably connected to the at least one central panel. At least one divider flap is foldably connected to the at least one central panel. The at least one attachment panel is positionable between a first position and a second position. In the first position the at least one attachment panel overlies and receives a portion of one or more of the containers. In the second position the at least one attachment panel is folded relative to the at least one central panel and in an upright position to form a handle for carrying the carrier.

According to another aspect of the disclosure, a blank for forming a carrier for holding a plurality of containers comprises a plurality of panels comprising at least one central panel and at least one attachment panel for receiving a portion of one or more containers of the plurality of containers. The at least one attachment panel is foldably connected to the at least one central panel, and the at least one central panel is for being positioned between adjacent containers of the plurality of containers when the carrier is formed from the blank. At least one divider flap is foldably connected to the at least one central panel. The at least one attachment panel is positionable between a first position and a second position. In the first position the at least one attachment panel overlies and receives a portion of one or more of the containers when the carrier is formed from the blank. In the second position the at least one attachment panel is folded relative to the at least one central panel and in an upright position to form a handle for carrying the carrier formed from the blank.

According to another aspect of the disclosure, a method of forming a carrier for holding a plurality of containers comprises obtaining a blank comprising a plurality of panels comprising at least one central panel and at least one attachment panel for receiving a portion of one or more containers of the plurality of containers. The at least one attachment panel is foldably connected to the at least one central panel. The blank comprises at least one divider flap foldably connected to the at least one central panel. The method further comprises positioning the at least one central panel between adjacent containers of the plurality of containers, positioning the at least one attachment panel in a first position in which the at least one attachment panel overlies and receives a portion of one or more of the containers, and positioning the at least one attachment panel in a second position in which the at least one attachment panel is folded relative to the at least one central panel and in an upright position to form a handle for carrying the carrier.

According to another aspect of the disclosure, a package comprises a plurality of containers and a carrier. The carrier comprises a plurality of panels comprising at least one central panel and at least one attachment panel receiving a portion of one or more containers of the plurality of containers. The at least one central panel is positioned between adjacent containers of the plurality of containers, and the at least one attachment panel is foldably connected to the at least one central panel. The carrier comprises at least one divider flap foldably connected to the at least one central panel. The at least one attachment panel is positionable between a first position and a second position. In the first position the at least one attachment panel overlies and receives a portion of one or more of the containers. In the second position the at least one attachment panel is folded relative to the at least one central panel and in an upright position to form a handle for carrying the package.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures. It is within the scope of the present disclosure that the above-discussed aspects be provided both individually and in various combinations.

According to common practice, the various features of the drawings discussed below are not necessarily drawn to scale. Dimensions of various features and elements in the drawings may be expanded or reduced to more clearly illustrate the embodiments of the disclosure.

FIG. 1 is a plan view of an outer surface of a blank for forming a carrier according to a first exemplary embodiment of the disclosure.

FIG. 2 is a perspective view of a partially folded configuration of a carrier formed from the blank of FIG. 1 according to the first exemplary embodiment.

FIG. 3 is a front view of a package and carrier formed from the blank of FIG. 1 in a first configuration and having a pair of containers removed according to the first exemplary embodiment.

FIG. 4 is a perspective view of the package and carrier of FIG. 3 including the removed pair of containers.

FIG. 5 is a perspective view of the package and carrier of FIG. 4 in a second configuration.

FIG. 6 is a plan view of an outer surface of a blank for forming a carrier according to a second exemplary embodiment of the disclosure.

FIG. 7 is a perspective view of a partially folded configuration of a carrier formed from the blank of FIG. 6 according to the first exemplary embodiment.

FIG. 8 is a front view of a package and carrier formed from the blank of FIG. 6 in a first configuration and having a pair of containers removed according to the second exemplary embodiment.

FIG. 9 is a perspective view of the package and carrier of FIG. 8 including the removed pair of containers.

FIG. 10 is a perspective view of the package and carrier of FIG. 9 in a second configuration.

Corresponding parts are designated by corresponding reference numbers throughout the drawings.

### DETAILED DESCRIPTION OF THE EXEMPLARY EMBODIMENTS

The present disclosure generally relates to carriers, packages, constructs, sleeves, cartons, or the like, for holding and displaying containers such as jars, bottles, cans, etc. The containers can be used for packaging food and beverage products, for example. The containers can be made from materials suitable in composition for packaging the particular food or beverage item, and the materials include, but are not limited to, glass; plastics such as PET, LDPE, LLDPE, HDPE, PP, PS, PVC, EVOH, and Nylon; and the like; aluminum and/or other metals; or any combination thereof.

Carriers according to the present disclosure can accommodate containers of numerous different shapes. For the purpose of illustration and not for the purpose of limiting the scope of the disclosure, the following detailed description describes beverage containers (e.g., aluminum cans) at least partially disposed within the carrier embodiments. In this specification, the terms “lower,” “bottom,” “upper,” “top,” “front,” and “back” indicate orientations determined in relation to fully erected carriers.

As described herein, carriers may be formed by multiple overlapping panels, end flaps, and/or other portions of blanks. Such panels, end flaps, and/or other portions of the blanks can be designated in relative terms to one another, e.g., “first”, “second”, “third”, etc., in sequential or non-sequential reference, without departing from the disclosure.

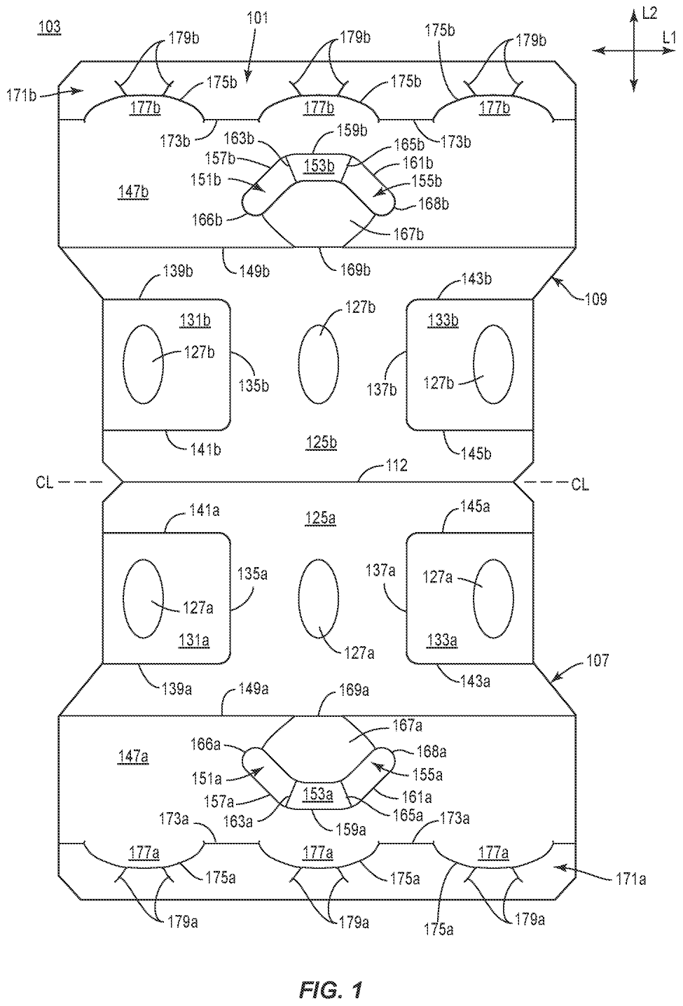

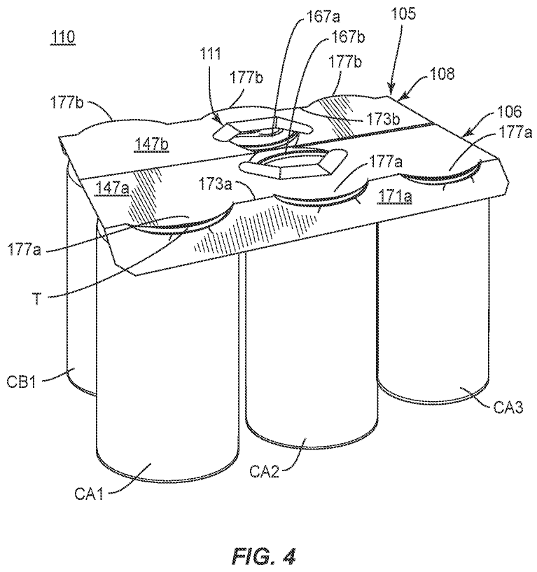

FIG. 1 shows a plan view of an exterior side 101 of a blank 103 used to form a handle assembly or carrier 105 (FIG. 4) in accordance with a first exemplary embodiment of the disclosure. As shown in FIG. 4, the carrier 105 is sized to contain or support six containers, with three containers CA1, CA2, CA3 being attached to a front portion 106 of the carrier 105 and three containers CB1, CB2, CB3 being attached to a back portion 108 of the carrier 105. In the illustrated embodiment, the containers CA1, CA2, CA3, CB1, CB2, CB3 can be beverage cans, or could be any other suitable type and size of container without departing from the disclosure. The carrier 105 can be sized and shaped to hold more or less than six containers. In one embodiment, the front portion 106 and the back portion 108 of the carrier 105 each have three containers, and in other embodiments, the front portion 106 and the back portion 108 of the carrier 105 can carry more or less than three containers without departing from the disclosure. The carrier 105 can be provided together with one or more containers as a package 110 (FIG. 4).

As shown in FIG. 1, the blank 103 has a longitudinal axis L2 and a lateral axis L1. The blank 103 has a front portion 107 for forming the front portion 106 of the carrier 105 (FIG. 4), and a back portion 109 for forming the back portion 108 of the carrier 105 (FIG. 4). The front portion 107 and the back portion 109 of the blank 103 are foldably connected at a lateral fold line 112 that forms a lateral centerline CL of the blank 103, as shown. As discussed further below, the blank 103 is at least partially formed into the carrier 105 by folding the blank 103 at the fold line 112 along the centerline CL so that one or more portions of the front portion 107 and the back portion 109 of the blank 103 are overlapped in at least partial face-to-face contact.

In the illustrated embodiment, the front portion 107 of the blank 103 comprises a front central panel 125a with an adhesive or glue opening 127a at a central portion thereof. A first front divider flap 131a and a second front divider flap 133a are foldably connected to the front central panel 125a at respective lateral fold lines 135a, 137a, and are defined by respective cuts 139a, 141a and 143a, 145a that extend from free edges of the front central panel 125a to endpoints of the respective fold lines 135a, 137a. In one embodiment, one or more of the respective cuts 139, 141a, 143a, 145a can include a curved portion, for example, adjacent the respective fold line 135a, 137a.

As shown, each divider flap 131a, 133a includes a glue opening 127a on an interior portion thereof. As shown, the glue openings 127a can have a similar configuration, e.g., an ovoid configuration, as shown, or one or more of the glue openings 127a can have a different configuration, e.g., a circular, square, triangular, rectangular, or other polygonal or closed curved profile.

A front handle panel or front attachment panel 147a is foldably connected to the front central panel 125a at a lateral top or fold line 149a. A plurality of handle reinforcement flaps 151a, 153a, 155a are foldably connected to the front attachment panel 147a at a respective oblique fold line 157a, lateral fold line 159a, and oblique fold line 161a, and extend into a handle opening 167a in the attachment panel 147a. The handle reinforcement flap 151a is separated from the handle reinforcement flap 153a at an oblique cut 163a and the handle reinforcement flap 153a is separated from the handle reinforcement flap 155a at an oblique cut 165a. Respective curved cuts 166, 168 can also be provided, for example, intersecting the respective fold lines 157a, 161a and the handle opening 167a, to provide for separation of the respective handle reinforcement flaps 151a, 155a from respective portions of the attachment panel 147a. The handle opening 167a extends from free edges of the handle reinforcement flaps 151a, 153a, 155a to the central panel 125a to define a free edge 169a of the central panel 125a that interrupts the fold line 149a.

Container receiving or attachment features in the front portion 107 of the blank 103 include a front bevel panel or front retention flap 171a foldably connected to the front attachment panel 147a at a lateral fold line 173a that is interrupted by curved cuts 175a that extend toward the front retention flap 171a and which define retention tabs 177a that protrude from the front attachment panel 147a. The cuts 175a can have one or more curved or angled portions, and one or more relief cuts 179a extending obliquely from one or more portions thereof into the front retention flap 171a to provide flexible reconfiguration of one or more portions of the attachment features of the blank 103 upon receipt of one or more container.

In the illustrated embodiment, the back portion 109 of the blank 103 includes a back central panel 125b, a back attachment panel 147b, back retention flaps 171b, and back divider flaps 131b, 133b having associated features that are generally a mirror-image of the corresponding panels and flaps of the front portion 107 of the blank 103. Corresponding components (e.g., panels, flaps, fold lines, cuts, etc.) have been designated by corresponding reference numbers that differ by the “a” or “b” suffix, with the “a” components corresponding to the front portion 107 of the blank 103 and the “b” components corresponding to the back portion 109 of the blank 103.

Any of the panels, flaps, fold lines, cuts, or other features could be otherwise shaped, arranged, and/or omitted from the blank 103 without departing from the disclosure. The blank 103 could be sized and/or shaped to accommodate more or less than six containers without departing from this disclosure.

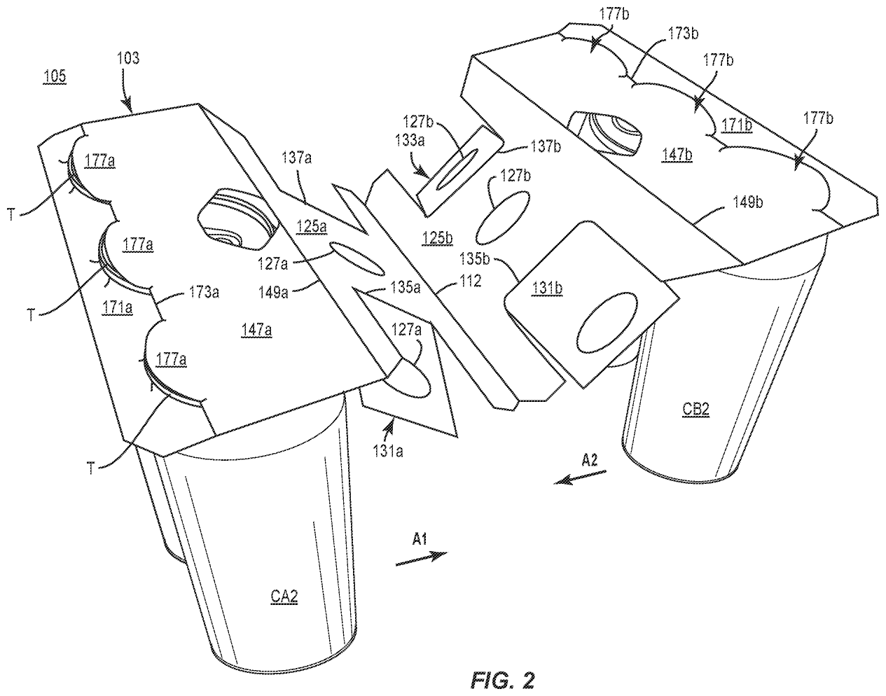

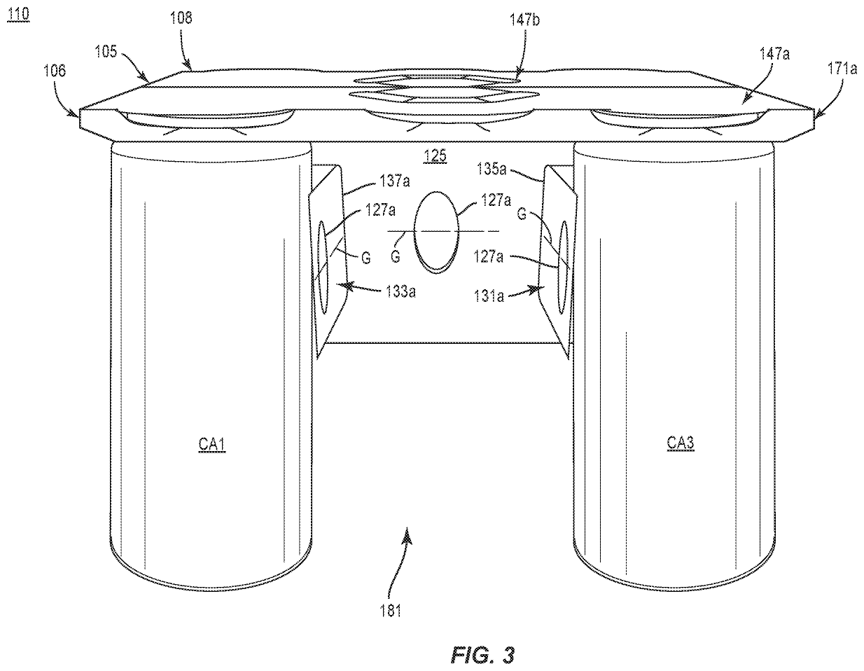

In one embodiment, and referring additionally to FIGS. 2 and 3, the front attachment panel 147a and the back attachment panel 147b are configured to receive a portion of one or more of the respective containers CA1, CA2, CA3 and CB1, CB2, CB3. In this regard, the exterior surface of the blank 101 at the respective front attachment panel 147a and back the attachment panel 147b can be placed over a top portion T, e.g., rims, of the respective containers CA1, CA2, CA3 and CB1, CB2, CB3, such that the top portions T of the respective containers CA1, CA2, CA3 and CB1, CB2, CB3 extend through the respective cuts 175a, 175b to be at least partially engaged by adjacent edges of the respective attachment panels 147a, 147b and the respective retention flaps 171a, 171b. In addition, the respective retention flaps 171a, 171b can be urged or otherwise folded downwardly at the respective fold lines 173a, 173b to be arranged obliquely relative to the respective attachment panels 147a, 147b such that the respective retention tabs 177a, 177b at least partially separate from the respective retention flaps 171a, 171b. In such an arrangement, the respective containers CA1, CA2, CA3, CB1, CB2, CB3 are at least partially retained between a respective retention tab 177a, 177b and a respective retention flap 171a, 171b. In one embodiment, one or more of the retention tabs 177a, 177b can engage a portion of a respective container CA1, CA2, CA3, CB1, CB2, CB3, e.g., a recessed portion of a respective top adjacent a respective container rim.

As also shown, the front attachment panel 125a and the back attachment panel 125b can be folded at the fold line 112 and the central panels 125a, 125b can be moved into at least partial face-to-face contact in the direction of the respective arrows A1, A2 and such that the glue openings 127a, 127b in the respective central panels 125a, 125b are in general alignment such that the front portion 106 of the carrier 105 and the back portion of the carrier 105 are in communication through the respective glue openings 127a, 127b in the respective central panels 125a, 125b. Such movement of the front attachment panel 125a and the back attachment panel 125b can include downward folding of the respective front attachment panel 125a and the back attachment panel 125b at the respective fold lines 149a, 149b.

As shown in FIG. 3, in which the containers CA2, CB2 are removed for clarity of illustration, the front divider flaps 131a, 133a and the back divider flaps 131b, 133b can be separated from the respective front central panel 125a and the back central panel 125b at the respective cuts 139a, 141a, 143a, 145a and 139b, 141b, 143b, 145b and folded away from the respective front central panel 125a and the back central panel 125b at the respective fold lines 135a, 137a and 135b, 137b to be positioned in a generally perpendicular and outwardly-extending arrangement relative to the respective front central panel 125a and the back central panel 125b so that the divider flaps 131a, 133a can be placed between respective adjacent containers. In this regard, container receiving spaces 181 can be defined in the front portion 106 and the back portion 108 of the carrier 105 adjacent respective divider flaps 131a, 131b, 133a, 133b. In one embodiment, respective container receiving spaces 181 can be provided for the respective containers CA1, CA2, CA3 (broadly, a respective “first container receiving space”, “second container receiving space”, and “third container receiving space”) and the containers CB1, CB2, CB3 (broadly, a respective “first container receiving space”, “second container receiving space”, and “third container receiving space”). While only the containers CA1, CA3, CB1, CB3 are illustrated in FIG. 3 for clarity of illustration, it will be understood that all of the containers CA1, CA2, CA3 and CB1, CB2, CB3 can be engaged with the respective handle panels 147a, 147b as described above.

Accordingly, one or more of the containers CA1, CA2, CA3, CB1, CB2, CB3 can be loaded into the container receiving spaces 181 of the carrier 105 to form the package 110. In the illustrated carrier 105, containers CA1, CA2, and CA3 are located in the container receiving spaces 181 of the front portion 106 of the carrier 105, and containers CB1, CB2, and CB3 are located in the container receiving spaces 181 of the back portion 108 of the carrier 105. As shown in FIGS. 2 and 3, the glue openings 127a in the respective divider flaps 131a, 133a, 131b, 133b provide communication between adjacent container receiving spaces 181 and respective containers CA1, CA2, CA3, CB1, CB2, CB3 such that a line or other arrangement of adhesive such as glue G can be applied across the respective glue openings 127a and onto adjacent portions of the respective divider flaps 131a, 133a. In this regard, glue G is provided to adhere the containers CA1 and CA2 to the divider flap 133a and to each other through the respective glue opening 127a in the divider flap 133a, and the glue G is provided to adhere the containers CA2 and CA3 to the divider flap 131a and to each other through the respective glue opening 127a in the divider flap 131a. It will be understood that the containers CB1, CB2, and CB3 are adhered to each other and to the respective divider flaps 133b, 131b with lines of glue G in a substantially similar or identical manner as the containers CA1, CA2, and CA3 as described above.

Additionally, at least the centrally-disposed containers CA2 and CB2 are adhered to each other through the respective glue openings 127a, 127b in the respective front central panel 125a and the back central panel 125b with a line of glue G across the respective glue openings 127a, 127b such that every container CA1, CA2, CA3, CB1, CB2, CB3 is adhered to each other, directly or indirectly through other containers, as well as to one or more portions of the carrier 105. Such lines of glue G that adhere the containers CA2, CB2 to one another through the central glue openings 127a can also extend onto respective portions of the respective central panels 125a, 125b such that one or both of the containers CA2, CB2 can additionally be adhered to portions of the respective central panels 125a, 125b. It will be understood that additional lines or arrangements of adhesive can be provided among containers CA1, CA2, CA3, CB1, CB2, CB3 and/or portions of the carrier 105. For example, in one embodiment, glue G can be provided between containers CA1, CB1 or CA3, CB3 through an opening in the central panels 125a, 125b formed by the separation of a respective divider flap 133a, 133b or 131a, 131b therefrom.

The glue G described herein can be, for example, a hot melt adhesive, a high tack glue, an epoxy, a polymeric cement, etc., or combinations thereof.

As shown in FIG. 4, in a first configuration of the carrier 105, e.g., a storage and/or transport configuration of the carrier 105, the attachment panels 147a, 147b are in a first position that is folded downwardly at the respective fold lines 149a, 149b to at least partially overlie and engage the top portions T of the respective containers CA1, CA2, CA3 and CB1, CB2, CB3 so as to receive a portion therethrough, as described above.

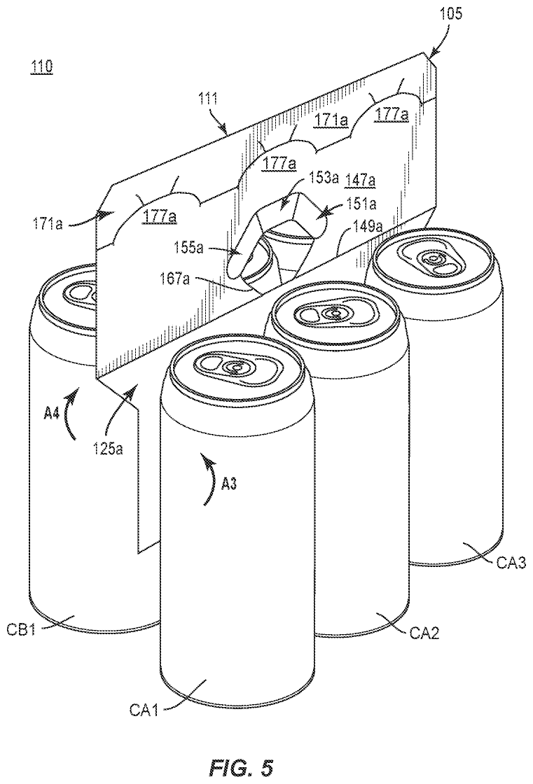

Referring additionally to FIG. 5, in a second configuration of the carrier 105, e.g., a carrying configuration of the carrier 105, the attachment panels 147a, 147b and retention flaps 171a, 171b can be disengaged or detached from the respective containers CA1, CA2, CA3, CB1, CB2, CB3 and the handle panels 147a, 147b can be folded upwardly at the respective fold lines 149a, 149b in the direction of the respective arrows A3, A4 into at least partial face-to-face or otherwise overlapping contact and such that the handle openings 167a, 167b are generally aligned. Such an upright position and arrangement of the attachment panels 147a, 147b (broadly, “second position” of the attachment panels 147a, 147b) provides a handle 111 that a customer can grasp, for example, through the handle openings 167a, 167b, to carry the package 110/carrier 105. In this regard, the attachment panels 147a, 147b are repositionable relative to the respective central panels 125a, 125b such that in the first configuration of the carrier 105, the respective attachment panels 147a, 147b are configured as attachment panels for engaging and receiving a portion of one or more of the respective containers CA1, CA2, CA3 and CB1, CB2, CB3, and in the second configuration of the carrier 105, the respective attachment panels 147a, 147b are configured as handle panels that provide the handle 111 for carrying the carrier 105.

One or more of the handle reinforcement flaps 151a, 153a, 155a, 151b, 153b, 155b can be at least partially folded at the respective fold lines 157a, 159a, 161a, 157b, 159b, 161b into at least partially overlapping relation with a respective attachment panel 147a, 147b, for example, to provide a layered structure, e.g., having a 4-ply configuration, that provides additional carrying strength and/or comfort to the customer.

The package 110 described above provides a carrier 105 with a compact structure that can, for example, provide materials savings and waste reduction. Additionally, the arrangement of the glue G among the containers CA1, CA2, CA3, CB1, CB2, CB3 as well as the divider flaps 131a, 131b, 133a, 133b and the central panels 125a, 125b provides multiple points of attachment that results in a robust structure for holding and carrying the containers CA1, CA2, CA3, CB1, CB2, CB3. Further, the exposure of one or more portions of the containers CA1, CA2, CA3, CB1, CB2, CB3 on exterior portions of the carrier 105/package 110 provides a customer with a clear view of labeling or surface graphics associated with the containers CA1, CA2, CA3, CB1, CB2, CB3 as well as providing convenient access to remove one or more of the containers CA1, CA2, CA3, CB1, CB2, CB3 from the carrier 105/package 110, for example, by peeling a respective container away from an adjacent container and/or portion of the carrier 105 to overcome the adhesion of respective glue G that adheres a respective container to a respective portion of the package 110. In one embodiment, the glue G can be selected so as to remain on a respective central panel 125a, 125b and/or respective divider flap 131a, 133a, 131b, 133b, e.g., such that substantially little or no glue G remains on the container as it is removed. One or more of the containers CA1, CA2, CA3, CB1, CB2, CB3, in one embodiment, can be reattached to a respective central panel 225a, 225b following therefrom by pressing the container against a respective region of glue G.

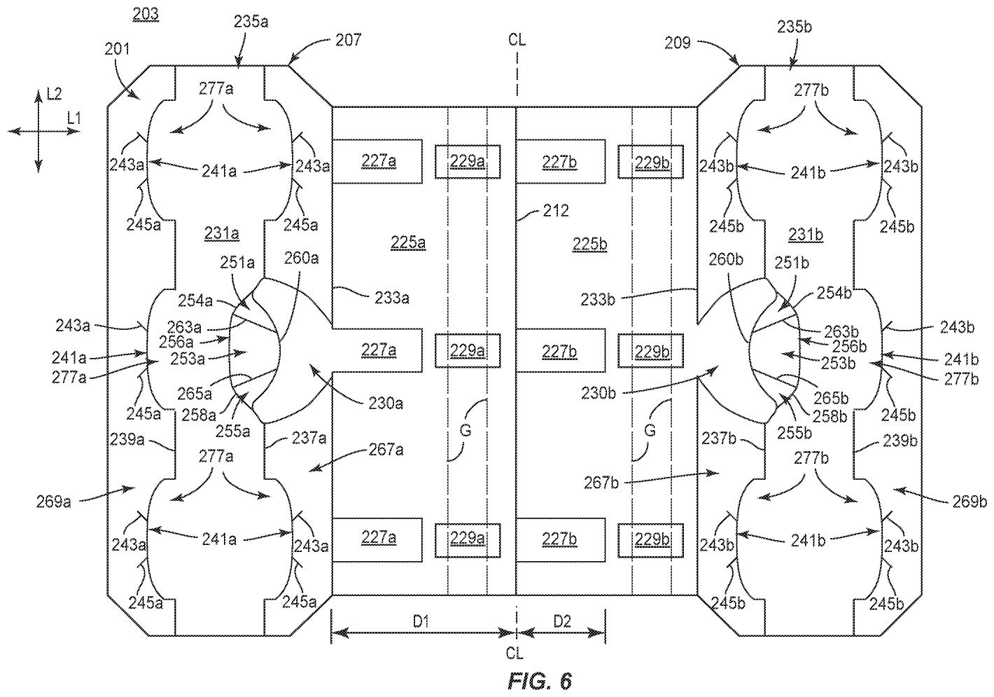

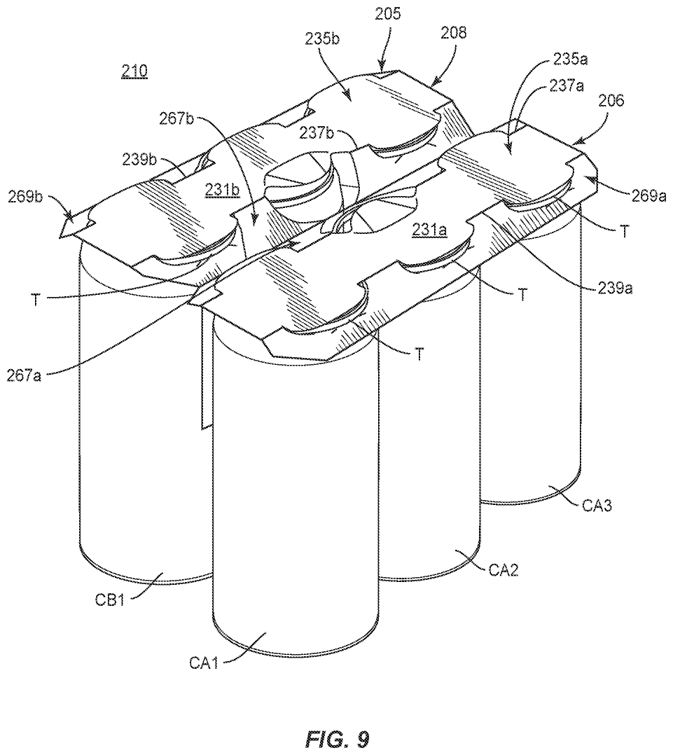

FIG. 6 shows a plan view of an exterior side 201 of a blank 203 used to form a handle assembly or carrier 205 (FIG. 9) in accordance with a second exemplary embodiment of the disclosure. The blank 203, carrier 205, and associated package 210 including one or more containers can have one or more features that are substantially similar to those of the respective blank 103 (FIG. 1), carrier 105, and package 110 (FIG. 4) of the first exemplary embodiment of the disclosure, and like or similar reference numbers are used to designate like or similar features.

As shown in FIG. 6, the blank 203 has a longitudinal axis L1 and a lateral axis L2. The blank 203 has a front portion 207 for forming the front portion 206 of the carrier 205 (FIG. 9), and a back portion 209 for forming the back portion 208 of the carrier 205. The front portion 207 and the back portion 209 of the blank 203 are foldably connected at a lateral fold line 212 that forms a lateral centerline CL of the blank 203, as shown. As discussed in further detail below, the blank 203 is partially formed into the carrier 205 by folding the blank 203 at the fold line 212 along the centerline CL so that the front portion 207 and the back portion 209 of the blank 203 are overlapped in at least partial face-to-face contact.

In the illustrated embodiment, the front portion 207 of the blank 203 comprises a front central panel 225a having a pair of adhesive or glue openings 227a at interior portions thereof and a pair of surface features 229a adjacent the respective glue openings 227a. The surface features 229a can be, for example, an embossed feature or other at least partially raised or recessed surface configuration. As shown, the top edges of the respective glue openings 227a are spaced a longitudinal distance D1 away from the centerline CL that is greater than a longitudinal distance D2 that the top edges of respective glue openings 227b of the back portion 209 of the blank 203 are spaced away from the centerline CL. As also described further herein, the central glue opening 227a intersects a handle opening 230a that extends into the attachment panel 231a such that the central glue opening 227a and the handle opening 230a are in communication with one another.

A front handle panel or front attachment panel 231a is foldably connected to the front central panel 225a at a lateral fold line 233a that is interrupted by the top edges of the respective glue openings 227a and/or a portion of the handle opening 230a. The front attachment panel 231a includes a container retention portion 235a that is at least partially defined between a pair of longitudinally-spaced lateral fold lines 237a, 239a (broadly, “second fold line” and “first fold line”, respectively. As shown, the lateral fold line 239a is interrupted by a set of three longitudinally-spaced cuts 241a that can each include one or more curved and/or angled portions, and the lateral fold line 237a is interrupted by a pair of the longitudinally-spaced cuts 241a that are opposite the respective longitudinally outermost cuts 241a that interrupt the fold line 239a. Respective oblique cuts 243a, 245a extend outwardly from each respective cut 241a to permit flexible reconfiguration of one or more portions of the attachment panel 231a upon receipt of one or more container. As shown, an interior marginal portion 267a of the attachment panel 231a is defined between the fold lines 237a, 233a, and the fold line 239a defines a front bevel panel or front retention flap or an exterior marginal portion 269a of the attachment panel 231a. In this regard, the longitudinally-spaced cuts 241a extend toward respective portions of the interior marginal portion 267a and the front retention flap or exterior marginal portion 269a, and define respective retention tabs 277a extending from the container retention portion 235a.

As also shown, the blank 203 includes handle features that include a plurality of handle reinforcement flaps 251a, 253a, 255a that are foldably connected to the attachment panel 231a at a respective oblique fold line 254a, a lateral fold line 256a, and an oblique fold line 258a, and which extend into the handle opening 230a. The handle reinforcement flap 251a is separated from the handle reinforcement flap 253a at an oblique cut 263a, and the handle reinforcement flap 253a is separated from the handle reinforcement flap 255a at an oblique cut 265a. In the illustrated embodiment, free edges of the handle reinforcement flaps 251a, 253a, 255a form a curved edge 260a that is adjacent the handle opening 230a.

In the illustrated embodiment, the back portion 209 of the blank 203 includes a back central panel 225b and a back handle panel or back attachment panel 231b having associated features that are generally a mirror-image of the corresponding panels and flaps of the front portion 207 of the blank 203. Corresponding components (e.g., panels, flaps, fold lines, cuts, etc.) have been designated by corresponding reference numbers that differ by the “a” or “b” suffix, with the “a” components corresponding to the front portion 207 of the blank 203 and the “b” components corresponding to the back portion 209 of the blank 203.

As also shown, glue G can be applied to one or more portions of the central panels 225a, 225b, e.g., across the respective surface features 229a, 229b. While the glue G is illustrated on the exterior surface 201 of the blank 203 in FIG. 6, it will be understood that the glue G can be applied to both the interior surface and the exterior surface of the central panels 225a, 225b without departing from the disclosure.

Any of the panels, flaps, fold lines, cuts, or other features could be otherwise shaped, arranged, and/or omitted from the blank 203 without departing from the disclosure. The blank 203 could be sized and/or shaped to accommodate more or less than six containers without departing from this disclosure.

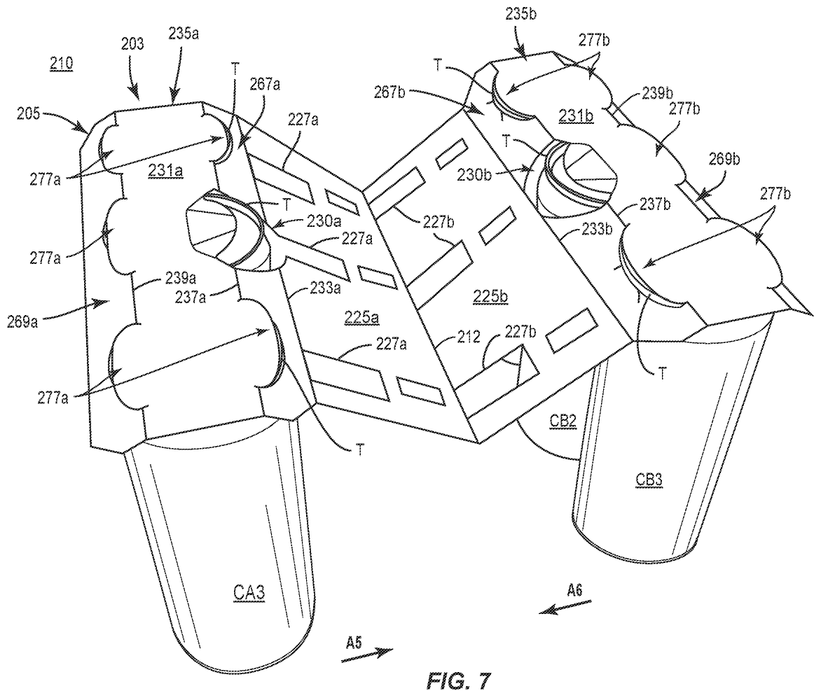

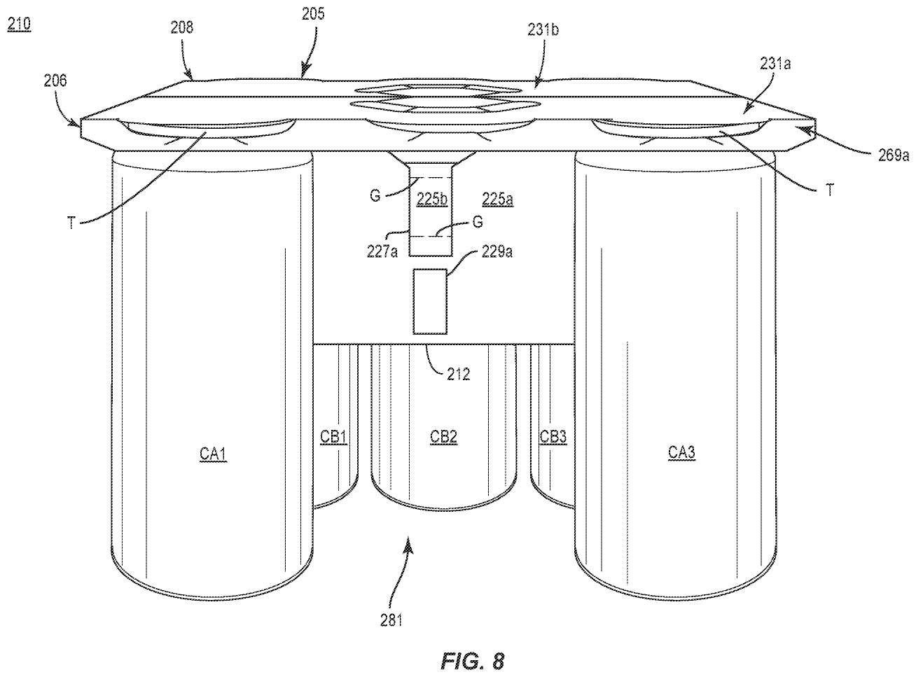

In one embodiment, referring additionally to FIGS. 7-9 (and noting that the glue G has been omitted from FIG. 7 for clarity of illustration), the interior surface or underside of the front attachment panel 231a and the back attachment panel 231b can be placed over a top portion T of the respective containers CAL CA2, CA3 and CB1, CB2, CB3, such that the top portions T of the respective containers CAL CA2, CA3 and CM, CB2, CB3 are received through the respective cuts 241a, 241b to be at least partially engaged by adjacent edges of the respective attachment panels 231a, 231b, the respective interior marginal portions 267a, 267b and the respective retention flaps or exterior marginal portions 269a, 269b. In addition, the respective interior marginal portions 267a, 267b and the respective exterior marginal portions 269a, 269b can be urged or otherwise folded downwardly at the respective fold lines 237a, 237b, 239a, 239b to be arranged obliquely relative to the respective container retention portions 235a, 235b of the respective attachment panels 231a, 231b.

In this regard, the respective retention tabs 277a, 277b can at least partially separate from the respective interior marginal portions 267a, 267b and respective exterior marginal portions 269a, 269b. In such an arrangement, the respective containers CAL CA2, CA3, CB1, CB2, CB3 are at least partially retained between a respective retention tab 277a, 277b and a respective marginal portion 267a, 269a and 267b, 269b. In one embodiment, one or more of the retention tabs 277a, 277b can engage a portion of a respective container CAL CA2, CA3, CB1, CB2, CB3, e.g., a recessed portion of a respective top adjacent a container rim.

The front central panel 225a and the back central panel 225b can be folded at the fold line 212 and the central panels 225a, 225b can be moved into at least partial face-to-face contact in the direction of the respective arrows A5, A6 such that the front central panel 225a and the back central panel 225b are in at least partial face-to-face contact and such that the respective glue openings 227a, 227b and the respective surface features 229a, 229b in the respective central panels 225a, 225b are positioned in general alignment so as to be laterally aligned but longitudinally offset due to the different relative spacing of the respective glue openings 227a, 227b away from the centerline CL.

In this regard, the central panels 225a, 225b are arranged such that a portion of the front central panel 225a overlaps each of the glue openings 227b and a portion of the back central panel 225b overlaps each of the glue openings 227a to provide respective surfaces upon which the respective containers CA1, CA2, CA3, CB1, CB2, CB3 can be adhered or otherwise attached, as described further herein. For example, glue G can be aligned with the glue openings 227a to provide an adhesion surface on a respective portion of the back central panel 225b, and glue G can be aligned with the glue openings 227b to provide adhesion surfaces on respective portions of the front central panel 225a. The glue G can cover at least a portion of the surface features 229a, 229b such that one or more of the surface features 229a, 229b presents additional surfaces for adhesion and/or spacing between the front portion 206 and the back portion 208 of the carrier 205.

The attachment of the containers CA1, CA2, CA3, CB1, CB2, CB3 to the respective central panels 225a, 225b can provide retention and support of the respective containers, e.g., such that the containers do not detach from the carrier 205 under their own weight, in addition to or alternative to the container retention and support provided by the respective container retention portions 235a, 235b. For example, in one embodiment, one or more of the containers CA1, CA2, CA3, CB1, CB2, CB3 can be attached to a respective central panel 225a, 225b with glue G, without additional retention and support provided by a container retention portion as described above, and as discussed further below.

Such enhanced attachment of the respective containers to the respective central panels 225a, 225b with the glue G can also provide enhanced integrity to the carrier 205, e.g., by providing opposing adhesive forces on the respective central panels 225a, 225b such that the central panels 225a, 225b are compressed therebetween. For example, in one embodiment, if the carrier 205 is lifted, the containers CA1, CA2, CA3 can at least partially pull the portions of the back central panel 225b to which they are attached through the respective glue openings 227a toward the front central panel 225a under the at least partial weight of the containers CA1, CA2, CA3. Respective portions of the front central panel 225a can be pulled toward the back central panel 225b through the respective glue openings 227b by the containers CB1, CB2, CB3 in a similar manner.

Accordingly, the attachment panels 247a, 247b are positionable relative to the respective central panels 125a, 125b such that in a first configuration of the carrier 205, e.g., a storage and/or transport configuration of the carrier 205, the respective attachment panels 231a, 231b are in a first position to overlie and receive a portion of the respective containers CA1, CA2, CA3 and CB1, CB2, CB3 that extend therebelow. In such an arrangement, containers CA1, CA2, CA3 extend below the container retention portion 235a in the front portion 206 of the carrier 205, and containers CB1, CB2, CB3 extend below the container retention portion 235b in the back portion 208 of the carrier 205.

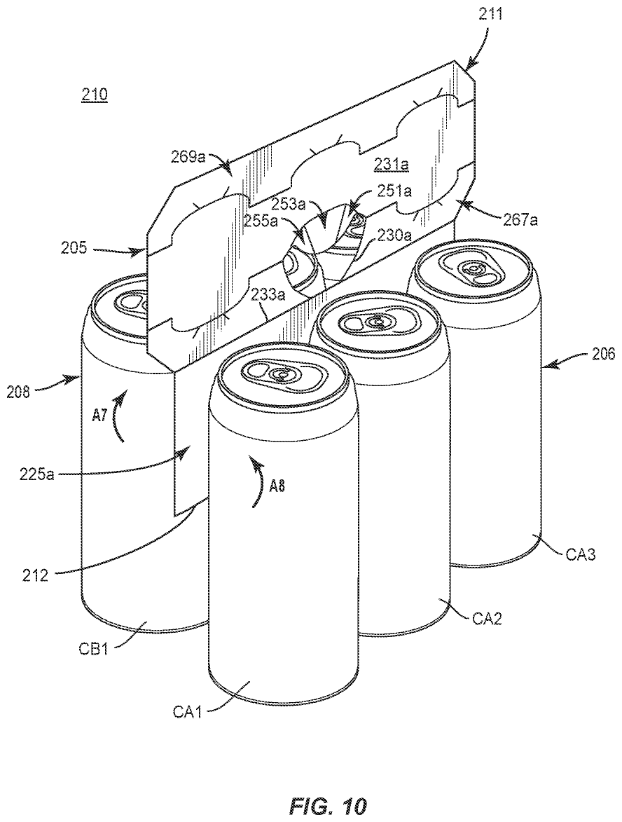

Referring additionally to FIG. 10, in a second configuration of the carrier 205, e.g., a carrying configuration of the carrier 205 (FIGS. 18-20), the attachment panels 231a, 231b can be detached from the respective containers CA1, CA2, CA3 and CB1, CB2, CB3, and the attachment panels 231a, 231b can be repositioned relative to the respective central panels 225a, 225b by folding the attachment panels 231a, 231b upwardly at the respective fold lines 233a, 233b in the direction of the respective arrows A6, A7 into at least partial face-to-face or otherwise overlapping contact and such that the handle openings 230a, 230b are generally aligned. Such upright arrangement of the attachment panels 231a, 231b (broadly, “second position” of the attachment panels 231a, 231b) provides a handle 211 that a customer can grasp, for example, through the handle openings 230a, 230b. One or more of the handle reinforcement flaps 251a, 253a, 255a, 251b, 253b, 255b can be at least partially folded at respective portions of the respective fold lines 256a, 256b into at least partially overlapping relation with a respective attachment panel 231, 231b, for example, to provide a layered structure that provides additional carrying strength and/or comfort. It will be understood that the carrier 205 can be selectively reconfigured between the first configuration and the second configuration to accommodate a desired application of the carrier 205.

The package 210 described above provides a carrier 205 with a compact structure that can, for example, provide materials savings and waste reduction. Additionally, the arrangement of the glue G among the containers CA1, CA2, CA3, CB1, CB2, CB3 and the respective central panels 225a, 225b provides multiple points of attachment that results in a robust structure for holding and carrying the containers CA1, CA2, CA3, CB1, CB2, CB3. Further, the exposure of one or more portions of the containers CA1, CA2, CA3, CB1, CB2, CB3 on exterior portions of the carrier 205/package 210 provides a customer with a clear view of labeling or surface graphics associated with the containers CA1, CA2, CA3, CB1, CB2, CB3, as well as providing convenient access to remove one or more of the containers CA1, CA2, CA3, CB1, CB2, CB3 from the carrier 205/package 210, for example, by peeling a respective container away from an adjacent or portion of the carrier 205 and/or an adjacent container.

Peeling or pulling the containers CA1, CA2, CA3, CB1, CB2, CB3 away from a respective central panel 225a, 225b can involve pulling the respective container with a force sufficient to overcome the adhesive bond of the respective container and the respective central panel 225a, 225b provided by the glue G. In one embodiment, the glue G can be selected so as to remain on a respective central panel 225a, 225b, e.g., such that substantially little or no glue G remains on the container as it is removed. One or more of the containers CA1, CA2, CA3, CB1, CB2, CB3, in one embodiment, can be reattached to a respective central panel 225a, 225b following therefrom by pressing the container against a respective region of glue G.

In general, the blank may be constructed from paperboard having a caliper so that it is heavier and more rigid than ordinary paper. The blank can also be constructed of other materials, such as cardboard, or any other material having properties suitable for enabling the carrier to function at least generally as described above. The blank can be coated with, for example, a clay coating. The clay coating may then be printed over with product, advertising, and other information or images. The blanks may then be coated with a varnish to protect information printed on the blanks. The blanks may also be coated with, for example, a moisture barrier layer, on either or both sides of the blanks. The blanks can also be laminated to or coated with one or more sheet-like materials at selected panels or panel sections.

As an example, a tear line can include: a slit that extends partially into the material along the desired line of weakness, and/or a series of spaced apart slits that extend partially into and/or completely through the material along the desired line of weakness, or various combinations of these features. As a more specific example, one type tear line is in the form of a series of spaced apart slits that extend completely through the material, with adjacent slits being spaced apart slightly so that a nick (e.g., a small somewhat bridging-like piece of the material) is defined between the adjacent slits for typically temporarily connecting the material across the tear line. The nicks are broken during tearing along the tear line. The nicks typically are a relatively small percentage of the tear line, and alternatively the nicks can be omitted from or torn in a tear line such that the tear line is a continuous cut line. That is, it is within the scope of the present disclosure for each of the tear lines to be replaced with a continuous slit, or the like. For example, a cut line can be a continuous slit or could be wider than a slit without departing from the present disclosure.

In accordance with the exemplary embodiments, a fold line can be any substantially linear, although not necessarily straight, form of weakening that facilitates folding therealong. More specifically, but not for the purpose of narrowing the scope of the present disclosure, fold lines include: a score line, such as lines formed with a blunt scoring knife, or the like, which creates a crushed or depressed portion in the material along the desired line of weakness; a cut that extends partially into a material along the desired line of weakness, and/or a series of cuts that extend partially into and/or completely through the material along the desired line of weakness; and various combinations of these features. In situations where cutting is used to create a fold line, typically the cutting will not be overly extensive in a manner that might cause a reasonable user to incorrectly consider the fold line to be a tear line.

The above embodiments may be described as having one or more panels adhered together by glue during erection of the carrier embodiments. The term “glue” is intended to encompass all manner of adhesives commonly used to secure carrier panels in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

What is claimed is:

1. A carrier for holding a plurality of containers, the carrier comprising:
a plurality of panels comprising at least one central panel and at least one attachment panel for receiving a portion of one or more containers of the plurality of containers, the at least one central panel is for being positioned between adjacent containers of the plurality of containers, the at least one attachment panel is foldably connected to the at least one central panel; and
at least one divider flap foldably connected to the at least one central panel;
the at least one attachment panel is positionable between a first position and a second position, in the first position the at least one attachment panel overlies and receives a portion of one or more of the containers, and in the second position the at least one attachment panel is folded relative to the at least one central panel and in an upright position to form a handle for carrying the carrier.

2. The carrier of claim 1, wherein, in the first position, the at least one attachment panel is attached to one or more containers of the plurality of containers, and in the second position, the at least one attachment panel is detached from the plurality of containers and configured as a handle panel that provides the handle.

3. The carrier of claim 1, wherein the at least one central panel is a front central panel, the carrier further comprises a back central panel in at least partial face-to-face contact with the front central panel, the attachment panel is a front attachment panel, and the carrier further comprises a back attachment panel.

4. The carrier of claim 3, wherein each of the front central panel and the back central panel comprise a respective glue opening, and the respective glue openings are longitudinally offset.

5. The carrier of claim 3, wherein each of the front central panel and the back central panel comprise a respective glue opening, and the respective glue openings are aligned such that a front portion of the carrier and a back portion of the carrier are in communication through the aligned glue openings.

6. The carrier of claim 1, wherein the at least one divider flap defines a first container receiving space and a second container receiving space adjacent the first container receiving space.

7. The carrier of claim 6, wherein the at least one divider flap comprises a glue opening with the first container receiving space and the second container receiving space in communication through the glue opening.

8. The carrier of claim 3, wherein the at least one divider flap comprises a front divider flap foldably connected to front central panel and a back divider flap foldably connected to the back central panel.

9. The carrier of claim 8, wherein the front divider flap defines at least a first container receiving space in the front portion of the carrier and the back divider flap defines a second container receiving space in the back portion of the carrier.

10. A blank for forming a carrier for holding a plurality of containers, the blank comprising:
a plurality of panels comprising at least one central panel and at least one attachment panel for receiving a portion of one or more containers of the plurality of containers, the at least one attachment panel is foldably connected to the at least one central panel, the at least one central panel is for being positioned between adjacent containers of the plurality of containers when the carrier is formed from the blank; and
at least one divider flap foldably connected to the at least one central panel;
the at least one attachment panel is positionable between a first position and a second position, in the first position the at least one attachment panel overlies and receives a portion of one or more of the containers when the carrier is formed from the blank, and in the second position the at least one attachment panel is folded relative to the at least one central panel and in an upright position to form a handle for carrying the carrier formed from the blank.

11. The blank of claim 10, wherein, in the first position, the at least one attachment panel is attached to one or more containers of the plurality of containers, and in the second position, the at least one attachment panel is detached from the plurality of containers and configured as a handle panel that provides the handle.

12. The blank of claim 10, wherein the at least one central panel is a front central panel, the blank further comprises a back central panel for being positioned in at least partial face-to-face contact with the front central panel when the carrier is formed from the blank, the attachment panel is a front attachment panel, and the blank further comprises a back attachment panel.

13. The blank of claim 12, wherein each of the front central panel and the back central panel comprise a respective glue opening, and the respective glue openings are positioned to be longitudinally offset when the carrier is formed from the blank.

14. The blank of claim 12, wherein each of the front central panel and the back central panel comprise a respective glue opening, and the respective glue openings are positioned to be aligned when the carrier is formed from the blank.

15. The blank of claim 10, wherein the at least one divider flap defines a first container receiving space and a second container receiving space adjacent the first container receiving space in the carrier formed from the blank.

16. The blank of claim 15, wherein the at least one divider flap comprises a glue opening and the first container receiving space and the second container receiving being in communication through the glue opening in the carrier formed from the blank.

17. The blank of claim 12, wherein the at least one divider flap comprises a front divider flap foldably connected to front central panel and a back divider flap foldably connected to the back central panel.

18. The blank of claim 17, wherein the front divider flap defines at least a first container receiving space in the front portion of the carrier formed from the blank and the back divider flap defines a second container receiving space in the back portion of the carrier formed from the blank.

19. A method of forming a carrier for holding a plurality of containers, the method comprising:
obtaining a blank comprising a plurality of panels comprising at least one central panel and at least one attachment panel for receiving a portion of one or more containers of the plurality of containers, the at least one attachment panel is foldably connected to the at least one central panel, the blank comprises at least one divider flap foldably connected to the at least one central panel;
positioning the at least one central panel between adjacent containers of the plurality of containers;
positioning the at least one attachment panel in a first position in which the at least one attachment panel overlies and receives a portion of one or more of the containers; and
positioning the at least one attachment panel in a second position in which the at least one attachment panel is folded relative to the at least one central panel and in an upright position to form a handle for carrying the carrier.

20. The method of claim 19, wherein, in the first position, the at least one attachment panel is attached to one or more containers of the plurality of containers, and in the second position, the at least one attachment panel is detached from the plurality of containers and configured as a handle panel that provides the handle.

21. The method of claim 19, wherein the at least one central panel is a front central panel, the carrier further comprises a back central panel in at least partial face-to-face contact with the front central panel, the attachment panel is a front attachment panel, and the carrier further comprises a back attachment panel.

22. The method of claim 21, wherein each of the front central panel and the back central panel comprise a respective glue opening, and the respective glue openings are longitudinally offset.

23. The method of claim 21, wherein each of the front central panel and the back central panel comprise a respective glue opening, and the respective glue openings are aligned such that a front portion of the carrier and a back portion of the carrier are in communication through the aligned glue openings.

24. The method of claim 19, further comprising positioning the at least one divider flap to define a first container receiving space and a second container receiving space adjacent the first container receiving space.

25. The method of claim 24, wherein the at least one divider flap comprises a glue opening and the first container receiving space and the second container receiving space are in communication through the glue opening.

26. The method of claim 21, wherein the at least one divider flap comprises a front divider flap foldably connected to front central panel and a back divider flap foldably connected to the back central panel.

27. The method of claim 26, further comprising positioning the front divider flap to define at least a first container receiving space in the front portion of the carrier and positioning the back divider flap to define a second container receiving space in the back portion of the carrier.

28. A package, comprising:
a plurality of containers; and
a carrier comprising:
a plurality of panels comprising at least one central panel and at least one attachment panel receiving a portion of one or more containers of the plurality of containers, the at least one central panel is positioned between adjacent containers of the plurality of containers, the at least one attachment panel is foldably connected to the at least one central panel, the carrier comprises at least one divider flap foldably connected to the at least one central panel;
the at least one attachment panel is positionable between a first position and a second position, in the first position the at least one attachment panel overlies and receives a portion of one or more of the containers, and in the second position the at least one attachment panel is folded relative to the at least one central panel and in an upright position to form a handle for carrying the package.

29. The package of claim 28, wherein, in the first position, the at least one attachment panel is attached to one or more containers of the plurality of containers, and in the second position, the at least one attachment panel is detached from the plurality of containers and configured as a handle panel that provides the handle.

30. The package of claim 28, wherein the at least one central panel is a front central panel, the carrier further comprises a back central panel in at least partial face-to-face contact with the front central panel, the attachment panel is a front attachment panel, and the carrier further comprises a back attachment panel.

31. The package of claim 30, wherein each of the front central panel and the back central panel comprise a respective glue opening, and the respective glue openings are longitudinally offset.

32. The package of claim 30, wherein each of the front central panel and the back central panel comprise a respective glue opening, and the respective glue openings are aligned such that a front portion of the carrier and a back portion of the carrier are in communication through the aligned glue openings.

33. The package of claim 28, wherein the at least one divider flap defines a first container receiving space and a second container receiving space adjacent the first container receiving space.

34. The package of claim 33, wherein the at least one divider flap comprises a glue opening and the first container receiving space and the second container receiving space are in communication through the glue opening.

35. The package of claim 30, wherein the at least one divider flap comprises a front divider flap foldably connected to front central panel and a back divider flap foldably connected to the back central panel.

36. The package of claim 35, wherein the front divider flap defines at least a first container receiving space in the front portion of the carrier and the back divider flap defines a second container receiving space in the back portion of the carrier.
